(19) United States
(12) Patent Application Publication
(10) Pub. No.: US 2009/0180731 A1
(43) Pub. Date: Jul. 16, 2009

(54) PHOTONIC COUPLER

(75) Inventors: Marc Peter Christensen, McKinney, TX (US); Duncan Leo MacFarlane, Dallas, TX (US); Gary Alan Evans, Plano, TX (US)

Correspondence Address: OBLON, SPIVAK, MCCLELLAND MAIER & NEUSTADT, P.C., 1940 DUKE STREET, ALEXANDRIA, VA, 22314, US

(73) Assignee: Southern Methodist University, Dallas, TX (US)

(21) Appl. No.: 12/350,007

(22) Filed: Jan. 7, 2009

Related U.S. Application Data
(60) Provisional application No. 61/006,320, filed on Jan. 7, 2008.

(51) Int. Cl. G02B 6/12

(52) U.S. Cl. 385/13; 385/14

(57) ABSTRACT

A photonic coupler including a substrate, first and second waveguides disposed along a longitudinal direction of the substrate for propagation of respective first and second optical signals along the longitudinal direction, and a coupling region between the first and second waveguides and including a medium of a refractive index different from the first and second waveguides. The coupling region has a width extending from the first waveguide to the second waveguide and a breadth extending laterally to form an angle to the longitudinal direction for frustrated total internal reflection of the first optical signal at an interface between the coupling region and the first waveguide.

### CROSS REFERENCE TO RELATED APPLICATIONS

This application is related and claims priority under 35 U.S.C. § 119(e) to U.S. Ser. No. 61/006,320 filed Jan. 7, 2008 entitled “PHOTONIC COUPLER” attorney docket number 300816US, the entire contents of which are incorporated herein by reference.

### BACKGROUND OF THE INVENTION

1. Field of the Invention

The invention relates to a photonic coupler for attenuating and/or splitting an electromagnetic signal that enters the photonic coupler. The invention further relates to a photonic coupler for combining a plurality of electromagnetic signals that enter the photonic coupler.

2. Discussion of the Background

Currently, photonic integrated circuits are used to process, filter, code, or modulate signals, and are also used for sensors. Application areas for photonic integrated circuits include telecommunication, biomedicine, instrumentation, and radar, as well as other areas. The type of photonic integrated circuitry and the application space are growing.

A typical photonic integrated circuit includes a plurality of wave guides, as well as other features, devices and optical components. For efficient photonic integrated circuits, the number of elements, waveguides, features, or components onto a substrate or die need to increase, and the size of the elements on the substrate or die need to decrease. Also, there is a need in photonic integrated circuits to increase the density of photonic integrated circuits.

The properties of a waveguide, and other features, devices and components, may be controlled by an applied control signal. Examples of applied control signals used in photonic integrated circuits include voltage, current, heat, and/or pressure control signals. Often the control signal varies an optical property of the material. For example, the amount of loss or gain of the material may be changed by the control signal. In another example, the index of refraction of the material is changed by the control signal. In another example, the nonlinear properties of the material are changed by the control signal.

Photonic integrated circuits can be made from a variety of materials. Lithium Niobate, for example, is one choice for electro-optic modulators. Moreover, waveguides are often fabricated in Lithium Niobate by diffusing an element, Titanium, for example, into Lithium Niobate substrate. The titanium doped Lithium Niobate has a slightly higher index of refraction than the undoped Lithium Niobate, and because of this property may be used as a waveguide.

Photonic integrated circuits may also be fabricated from Group III-V materials. Indeed, photonic integrated circuits made from InP or GaAs alloys are used presently in data communication and telecommunication applications. Of these two specific Group III-V materials, GaAs alloys are used to make modulators, lasers, and amplifiers in the near-infrared region. By designing the doping profiles, alloy compositions and the quantum well structures, GaAs devices can operate at wavelengths from 600-1200 nm. InP alloys can be used to make modulator lasers and amplifiers at longer wave-lengths. By designing the doping profiles, alloy compositions and quantum well structures, InP devices can operate at wavelengths from 1200-2000 nm. Often ridge waveguide are used in III-v photonic integrated circuits. To fabricate a ridge waveguide, a 2-3 nm wide, 1-2 um high ridge can be patterned and etched for example.

Other material systems used in photonic integrated circuits include polymers such as SU-8, a viscous negative photoresist material, and other more traditional device materials such as for example SiO₂, and SiO₂ on Silicon, and silicon.

A photonic coupler is a common component of a photonic integrated circuit. A photonic coupler can be used to split a photonic signal into a plurality of signals. A photonic coupler can be used to combine a plurality of photonic signals into a composite photonic signal. A photonic coupler can be used to mix together a plurality of input photonic signals and generate a plurality of output photonic signals. A photonic coupler can be used to sort photonic signals by a parameter, for example wavelength or frequency. A photonic coupler can be used to attenuate a signal or plurality of photonic signals.

Photonic integrated circuits typically require a photonic coupler either to split an incoming electromagnetic signal into two or more outgoing signals or to reduce an intensity of the incoming signal. Photonic circuits also may require a photonic coupler to combine two or more incoming electromagnetic signals into one or more outgoing electromagnetic signals.

FIG. 1 is a schematic of a conventional photonic coupler referred to in the art as a “Y” adiabatic coupler 10. The Y adiabatic coupler includes an incoming waveguide 2 that gradually splits into two outgoing waveguides 4 such that an incoming signal is gradually split into two outgoing signals. The waveguides 2 and 4 shown in FIG. 1 are formed on a substrate 6. In practice, the separation angle θ depicted in FIG. 1 between the two outgoing waveguides 4 is a small in order to minimize the amount of scattering, or radiation, of signal out of the waveguides, which would result in energy loss from the two outgoing signals and increase the inefficiency of the coupler 10.

Because the outgoing waveguides 4 have a small separation angle θ, in practice, one extends the lengths of the two outgoing waveguides 4 in order to decouple the two outgoing signals, which results in a long adiabatic coupler 10 (i.e., between 100-1000 microns long) in the direction of A shown on FIG. 1. This large size for the conventional adiabatic coupler precludes dense integration of the photonic integrated circuits.

Prior work has been done in photonic crystal lattices trying to achieve the required performances of a photonic coupler and also to overcome the large size of the Y adiabatic coupler. However, the photonic crystals suffer from inherent poor coupling efficiency when the size of the photonic crystal becomes small as required by photonic integrated circuits. Photonic crystals must by their nature have a different index of refraction than the associated waveguides. The different index of refraction produces an impedance mismatch leading to poor coupling and undesirable back-reflection. Thus, the conventional devices that are used today in an effort to integrate photonic circuitry with electrical circuitry are either too large for this purpose (the Y adiabatic coupler) or provide poor performance (the photonic crystal lattices).

The invention addresses these problems and makes use of various technologies referenced and described in references below, the entire contents of each reference being incorporated herein by reference:
1. Bae, J. W., et al., “Characterization of sidewall roughness of InP/InGaAsP etched using inductively coupled plasma for low loss optical waveguide applications,” Journal of Vacuum Science and Technology B, 21, 2888-2891 (2003).
2. Carlstrom, C. F., et al., “C12/O2-inductively coupled plasma etching of deep hole-type photonic crystals in InP,” Journal of Vacuum Science and Technology B, 24, L6-L9 (2006).
3. Choi, S. J., Djordjev, K, Choi, S. J., Dapkus, P. D., “CH₄-based dry etching of High Q InP Microdisks,” Journal of Vacuum Science and Technology B, 20, 301-305 (2002).
4. Choy, K. L., “Chemical Vapour Deposition of Coatings,” Progress in Materials Science 48 (2), pp. 57-170 (2003).
5. J. J. Coleman, et al., “Progress in InGaAs-GaAs selective area MOCVD toward photonic integrated circuits,” IEEE J. Selected Topics in Quantum Electronics 3, 874-884 (1997).
6. Tiberiu Constantinescu, et al., “Composition Methods for Four-Port Couplers in Photonic Integrated Circuitry,” Journal of the Optical Society A 23, 2919 (2006).
7. Grover, Rohit, et al., “Process Development of Methane-Hydrogen-Argon Deep Dry Etching of InP for High Aspect Ration Structure with Vertical facet-quality Side walls,” Journal of Vacuum Science and Technology B, 19, 1694-1698 (2001).
8. L. Roberts Hunt, et al., “Active Optical Lattice Filters” EURASIP Journal on Applied Signal Processing 2005:10, 1452-1461 (2005).
9. R. Jones, et al., “Lossless Optical Modulation in a Silicon Waveguide Using Stimulated Raman Scattering,” Optics Express, 13, 1716-1723 (2005).
10. G. Kannan, et al., “Analysis and design of active optical filter structures with two-port couplers,” IEEE Journal of Lightwave Technology 24, 2637 (2006).
11. Kim, H., “Atomic layer deposition of metal and nitride thin films: Current research efforts and applications for semiconductor device processing,” Journal of Vacuum Science and Technology B: Microelectronics and Nanometer Structures 21, (6) pp 2231-2261 (2003).
12. J. Y. Kim., et al., “Remote plasma enhanced atomic layer depositon of TiN thin fibers using metalorgnic precursor,” J. Vac Scie Tech A 22, pp. 8-12 (2004)
13. Kotlyar, M. V., et al., “High-aspect-ratio chemically assisted ion-beam etching for photonic crystals using a high beam voltage-current ratio,” Journal of Vacuum Science and Technology B, 22, 1788-1791 (2004).
14. K. Kunz and R. Luebbers, The Finite Difference Time Domain for Electromagnetics, 1993, CRC Press Catalog Number 8657, 496 pages.
15. A. Liu, D. Samara-Rubio, L. Liao, and M. Paniccia, “Scaling the Modulation Bandwidth and Phase Efficiency of a Silicon Optical Modulator,” IEEE Journal of Selected Topics in Quantum Electronics, 367-372 (2005).
16. L. Liao, et al., “Phase Modulation Efficiency and Transmission Loss of Silicon Optical Phase Shifters,” IEEE Journal of Quantum Electronics, 41, 2, 250-257 (2005).
17. L. Liao, et al. “High Speed Silicon Mach-Zehnder Modulator,” Optics Express, 13, 8, 3129-3135 (2005).
18. A. Liu, D. Samara-Rubio, L. Liao, and M. Paniccia, “Scaling the Modulation Bandwidth and Phase Efficiency of a Silicon Optical Modulator,” IEEE Journal of Selected Topics in Quantum Electronics, 11, 2, 367-372 (2005).
19. A. Liu, H. Rong, R. Jones, O. Cohen, D. Hak, and M. Paniccia, “Optical Amplification and Lasing by Stimulated Raman Scattering in Silicon Waveguides,” IEEE Journal of Lightwave Technology, Volume 24 Issue 3, 1440-1455 (2006).
20. Martinu, Ludvik, Poitras, Daniel, “Plasma deposition of optical films and coatings: A review,” Journal of Vacuum Science and Technology A: Vacuum, Surfaces and Films” 18 (6), pp. 2619-2645 (2000).
21. Duncan L. MacFarlane and Eric M. Dowling, “Active optical lattice filters,” U.S. Pat. No. 6,687,461 issued Feb. 3, 2004.
22. Duncan L. MacFarlane, et al. “Extended Lattice Filters Enabled by Four Directional Couplers” Applied Optics 43, 6124 (2004).
23. Duncan L. MacFarlane, “Filter for selectively processing optical and other signals,” U.S. Pat. No. 7,042,657 B2, issued May 9, 2006.
24. Optical Filter Design and Analysis: A Signal Processing Approach, Christi K. Madsen, Jian H. Zhao, Wiley, 1999.
25. Mulot, M., et al., “Low Loss InP Photonic-Crystal Waveguides Etched with Ar/Cl2 Chemically Assisted Ion Beam Etching,” Journal of Vacuum Science and Technology B, 900-903 (2003).
26. Nakagawa, P-C Sun, C-H Chen, Y. Fainman, “Wide-field-of-view narrow-band spectral filters based on photonic crystal nanocavities,” Optics Letters, Vol. 27, Issue 3, p. 191 (February 2002).
27. V. Narayan, D. L. MacFarlane and E. M. Dowling, “Analysis and design of optical lattice filters in the presence of imperfections,” Optics Communications 110, 209 (1994).
28. V. Narayan, E. M. Dowling and D. L. MacFarlane, “Design of multi-mirror structures for high frequency bursts and codes of ultrashort pulses,” IEEE Journal of Quantum Electronics 30, 1671 (1994).
29. V. Narayan, D. L. MacFarlane and E. M. Dowling, “High speed discrete time optical filtering,” IEEE Photonics Technology Letters 7, 1042 (1995).
30. M. Notomi, “Negative refraction in photonic crystals” Optical and Quantum Elec., 34, 133 (2002)
31. O'Faolain, L., et al., “Fabrication of photonic crystals using a spin-coated hydrogen silsesquioxane hard mask,” Journal of Vacuum Science and Technology B, 24, 336-339 (2006).
32. R. Österbacka, et al., “Two-Dimensional Electronic Excitations in Self-Assembled Conjugated Polymer Nanocrystals” Science 287, 838 (2000).
33. Park, J. Li, X., and Huang, WP, “Performance simulation and design optimization of gain clamped semi-conductor optical amplifiers based on distributed Bragg reflectors,” IEEE J. Quant. Electron 39, pp. 1415-1423 (2003).
34. Dennis W. Prather, et al., “High-efficiency coupling structure for a single-line-defect photonic-crystal waveguide,” Optics Letters, Vol. 27 Issue 18 Page 1601 (September 2002)
35. S. Pradhan, et al., “A monolithically integrated 1.55 μm photoreceiver-laser driver optoelectronic integrated circuit”, Electronic Letters, vol. 38, no. 17, August 2002, p. 987-9
36. D. W. Prather, et al., “Dispersion-based optical routing in photonic crystals,” Optics Letters, Vol. 29, No. 1, January 2004.
37. Minghao Qi, et al., “A three-dimensional optical photonic crystal with designed point defects,” Nature 429, 538-542 (2004).
38. Radhakrishnan Nagarajan, et al., “Large-Scale Photonic Integrated Circuits,” IEEE J. Sel Topics in Quant. Electron., 50-65, 2005.
39. R. Nagarajan, et al., “400 Gbit/s (10 channel 40 Gbit/s) DWDM photonic integrated circuits,” Electronics Lett. 41, 6, Mar., 2005.
40. H. Rong, et al., “A Continuous-Wave Raman Silicon Laser,” Nature, 433, 725-728 (2005).
41. H. Rong, et al. “An All-Silicon Raman Laser,” Nature, 433, 292-294 (2005).
42. Sandra Zivanovic Selmic, et al., “Design and Characterization of 1.3 um AlGaInAs/InP Multiple Quantum Well Lasers, IEEE J. of Special Topics in Quantum Electronics 7, pp 340-349 (2001).
43. A. J. Seed, “Microwave Photonics,” IEEE Transactions on Microwave Theory and Techniques 50 (3), pp. 877-887 (2002).
44. Ahmed Sharkawy, et al., “High transmission through waveguide bends by use of polycrystalline photonic-crystal structures,” Optics Letters, Vol. 28 Issue 14 Page 1197 (July 2003)
45. H. Shin, et al., “Formation of TiO2 and ZrO2 nanotubes using atomic layer deposition with ultraprecise control of the wall thickness,” Advanced Materials 16 (14), pp. 1197-1200 (2004).
46. P. Strasser, et al., “Detailed analysis of the influence of inductively coupled plasma reactive ion etching process on the hole depth and shape of photonic crystals in InP/InGaAsP,” J. Vacuum Science and Technology B 25, 387-393 (2007).
47. Tangdiongga, et al., “Performance analysis of linear optical amplifiers in dynamic WDM systems,” IEEE Photonics Technology Letters 14(8), pp. 1196-1198 (2002).
48. Jian Tong, et al., “Active Integrated Photonic True Time Delay Device,” IEEE Photonics Technology Letters 18, 1720 (2006).
49. Jian Tong, et al., “Direct Form I Realization of Active Photonic Filters,” Submitted to Journal of Fiber and Integrated Optics (2006).
50. Verspurten, et al., “Experimental and numerical small-signal analysis of two types of gain clamped semiconductor optical amplifiers,” IEEE J. of Quant. Electron 42, pp. 302-312 (2006).
51. Yablonovitch E, Gmitter T J. Photonic band structure: the face-centered-cubic case. Physical Review Letters, vol. 63, no. 18, 30 Oct. 1989, pp. 1950-1953.
52. T. S. Yeoh, et al., “Epitaxy of InAs quantum dots on self organized two-dimensional InAs islands by atmospheric pressure metalorganic chemical vapor deposition,” Appl. Phys. Lett. 79, 221-223 (2001).
53. C. Y. Luo, et al., “Subwavelength Imaging in photonic crystals,” Phys. Rev. B, 68, 045115 (2003)
54. Anvar A. Zakhidov, et al., “Carbon Structures with three-dimensional periodicity at optical wavelengths,” Science 282, 897-901 (1998).

### SUMMARY OF THE INVENTION

In one embodiment of the invention, there is provided a photonic coupler including a substrate, first and second waveguides disposed along a longitudinal direction of the substrate for propagation of respective first and second optical signals along the longitudinal direction, and a coupling region between the first and second waveguides and including a medium of a refractive index different from the first and second waveguides. The coupling region has a width extending from the first waveguide to the second waveguide and a breadth extending laterally to form an angle to the longitudinal direction for frustrated total internal reflection of the first optical signal at an interface between the coupling region and the first waveguide.

In one embodiment of the invention, there is provided a method for processing optical signals. The method sends a first optical signal into a first waveguide of the photonic coupler, and splits the first optical signal at the coupling region described above.

The method transmits a part of energy from the first optical signal in the first waveguide across a width of the coupling region to form a second optical signal in the second waveguide, and transmits the second optical signal along a length of the second waveguide.

It is to be understood that both the foregoing general description of the invention and the following detailed description are exemplary, but are not restrictive of the invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic diagram of a conventional Y adiabatic coupler;

FIG. 2 is a schematic diagram of a photonic coupler with partial trench in a waveguide;

FIG. 3 is a schematic diagram of a photonic coupler according to one embodiment of the invention;

FIGS. 4A-B are schematic diagrams of the positions of a trench relative to a waveguide and a waveguide mode;

FIG. 5A is a schematic diagram illustrating the total internal reflection and FIG. 5B is a schematic diagram illustrating the frustrated total internal reflection;

FIG. 6 is a schematic illustrating a family of curves for various materials filling the trench in the waveguide;

FIG. 7 is a graph of experimental data from a coupler constructed schematically on the basis of FIG. 3;

FIG. 8 shows an electron microscope image of a coupler realized according to the structure depicted in FIG. 3;

FIG. 9A-1 is a false-color contour plot for “T” shaped waveguide structure according to one embodiment of the invention;

FIG. 9A-2 is a wavefront plot for the false-color contour plot of FIG. 9A-1;

FIG. 9B is a SEM micrograph of four port coupler according to one embodiment of the invention.

FIG. 10 shows the steps of a method for producing the photonic coupler according to one embodiment of the invention; and

FIG. 11 is a SEM micrograph of an alternative trench structure in a photonic coupler according to one embodiment of the invention.

### DESCRIPTION OF THE INVENTION

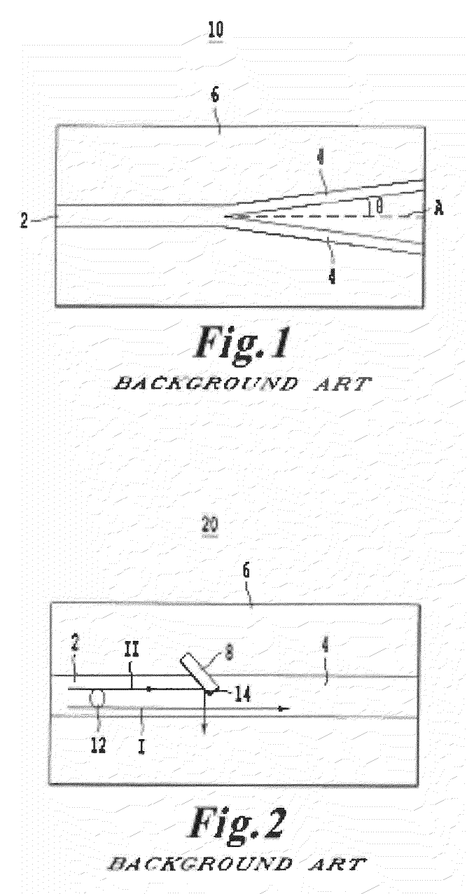

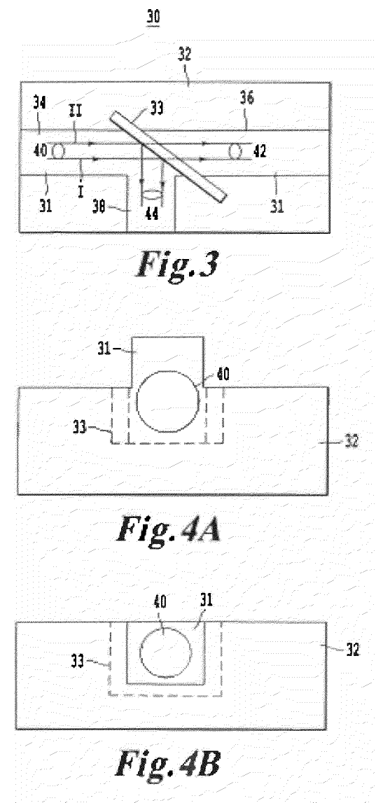

In an effort to overcome the above noted deficiencies of the conventional photonic couplers, several compact couplers have been developed with varying degrees of efficiency. Referring now to the drawings, wherein like reference numerals designate identical or corresponding parts throughout the several views, FIG. 2 shows a relatively low efficiency coupler as compared to several of the compact couplers described below. The efficiency of this coupler was around 35% in the tests performed. The coupler 20 shown in FIG. 2 includes an incoming waveguide 2 formed on a substrate 6. A trench 8 is formed partially in the waveguide 2. The portion of the waveguide extending from the trench 8 opposite to the incoming waveguide 2 is referred to as a first outgoing waveguide for analogy with the Y adiabatic coupler 10 shown in FIG. 1. Another portion of the waveguide extending from the trench 8 orthogonal to the incoming waveguide 2 is referred to as a second outgoing waveguide.

Trench 8 is made to only partially separate the incoming waveguide 2 from the outgoing waveguide 4. An incoming signal 12 (or plurality of signals) enter the incoming waveguide 2 and includes, for illustrative purposes, two portions I and II, which for simplicity will be called signal I and signal II. Signal I is able to continue its path along the waveguide 2 to the outgoing waveguide without being affected (i.e., scattered) by the trench 8. However, the path of the signal II is changed (i.e., partially reflected or refracted or scattered) by the trench 8. The size of the trench 8 in FIG. 2 is approximately 1 μm×1 μm×3 μm (deep).

For example, when signal II arrives at trench 8, if trench 8 includes air or other dielectric materials having an index of refraction different from the index of refraction of the incoming waveguide 2, wave II is deviated from its original direction. Thus, only a small part of signal II will continue into the outgoing waveguide 4. Meanwhile, as noted above, signal I is able to continue its path along the waveguide 2 to the outgoing waveguide 4 without being affected. In this way, the outgoing waveguide 4 has a lower intensity signal propagating then the incoming signal 12. Furthermore, that part of signal II which is reflected by the trench will propagate along outgoing waveguide 4. Hence, the incoming signal 12 is divided.

As noted above, the efficiency of coupler 20 is relatively low. One reason for the low efficiency concerns optical scattering due to edge effects produced by edge 14 of trench 8. Because wavefronts of the incoming signal 12 arrive at the edge 14, edge 14 becomes a source of spherical waves that propagate in various directions, contributing to the loss of energy from those signals propagating in 4a or 4b.

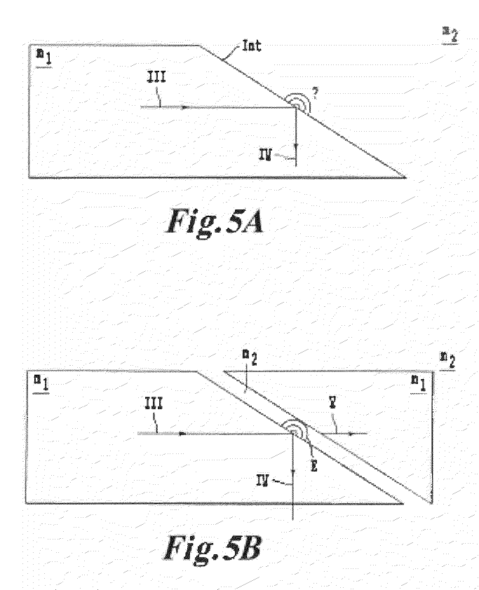

FIG. 3 is a schematic diagram of a photonic coupler 30 according to one embodiment of the invention, which recognizes improvements which can be realized when using frustrated internal reflection as a mechanism for optically dividing signals. Coupler 30 has a waveguide 31 formed on or in a substrate 32. A second outgoing waveguide 38 shown in FIG. 3 is an optional element for various embodiments of the invention. (See Sensing Device description below.) In one embodiment, the second outgoing waveguide 38 is made simultaneously with the incoming waveguide 34 and the first outgoing waveguide 36 to have a monolithic structure, and trench 33 is formed afterwards. The size of the trench is determined such that the total internal reflection of the light when reaching the trench is frustrated from 100% total internal reflection, and the width of the trench (as discussed later) determines what percentage of the light reaching the optical junction is transmitted into first outgoing waveguide 36 and second outgoing waveguide 38. In one embodiment, the trench is formed to substantially across waveguide 31.

Suitable waveguide materials and substrate materials when the waveguide is a part of the base substrate include materials such as for example polymers (e.g., SU8 and ploymethyacrylate PMMA) SiO₂ on Si, and III-V semiconductor materials (e.g., GaAs, InP, and GaN alloys). Suitable substrate materials include Si, and III-V semiconductor materials (e.g. GaAs, InP, and GaN). Suitable trench-fill materials (i.e., suitable mediums of a refractive index different from the waveguides) include air, polymers (including SU8 and PMMA), oxides, (including SiO₂, vanadium dioxide, titanium dioxide,) nitrides, (including silicon nitride, gallium nitride) and other dielectrics.

An optical junction is formed by the ends of waveguides 34, 36, and 38 that face trench 33 and any dielectric layer trench 33. It is the property of frustrated total internal reflection which determines the performance of the coupler 30 shown in FIG. 3. This in turn is dependent on a threshold angle determined by the total internal angle, i.e. the critical angle defined by Snell's law. Accordingly, the dielectric fill material and specifically its dielectric constant factor into determining the threshold angle here. Typically, the footprint of the coupler 30 shown in FIG. 3 is on the order of the width of the waveguide (approximately 3 micron in one embodiment). The coupler 30 shown in FIG. 3 represents a 100-fold reduction in footprint relative to the conventional coupler shown in FIG. 1.

The waveguide 31 in FIG. 3 can be configured as a ridge waveguide (i.e., a region of different optical index of refraction formed from a material deposited and patterned on the surface of the substrate) or a diffused waveguide (i.e., a region of different optical index of refraction formed in the substrate by diffusion doping of the substrate in selected regions). A trench 33 is formed (e.g., by etching) across the waveguide 31 such that an incoming waveguide 34 and a first outgoing waveguide 36 are formed separated by the trench 33.

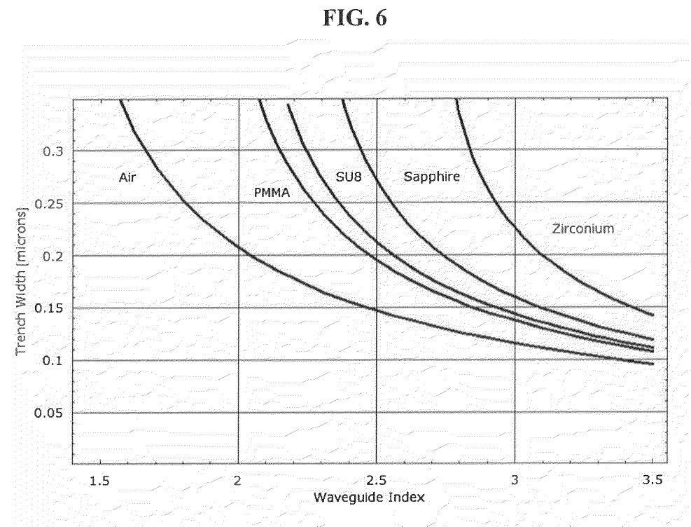

For illustrative purposes, FIG. 4A shows in cross section a ridge waveguide 31a and the waveguide mode 40 being propagated along the length of ridge waveguide 31a. The trench 33 in this embodiment is at least as deep as the waveguide mode 40 to completely intercept the mode. In another embodiment shown in FIG. 4B, the internal waveguide 31b and trench 33 are arranged such that trench 33 completely intercepts the waveguide mode 40 being propagated along the length of internal waveguide 31b.

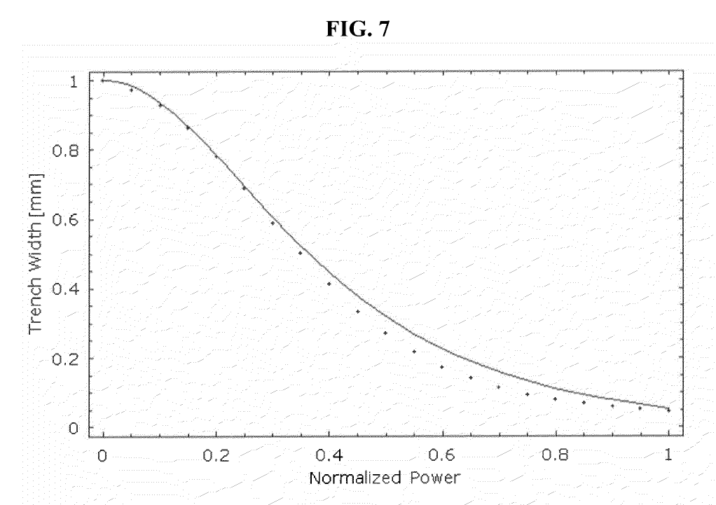

A detailed explanation of frustrated total internal reflection is given below for the purposes of one understanding better how to make and used the compact couplers of the invention in optical coupling and sensing devices. This detailed explanation is not to limit the claims beyond those terms defined in the claims. With reference to FIGS. 5A-B, conventional total internal reflection is illustrated in FIG. 5A. An incoming signal III propagates through a first medium having a first index of refraction n1. When the incoming signal III arrives at an interface Int, between the first medium and a second medium having a second index of refraction n2, the wave is totally internally reflected IV inside the first medium when n1 is higher than n2. Thus, in this situation, no light propagates from the first medium at the interface Int.

However, the situation is different in FIG. 5B. When a third medium (which in this illustrative example is identical to the first medium but might be a different medium) is close to the interface Int, as shown in FIG. 5B, the incoming signal III arrives at the Int (which corresponds to the trenches discussed above), and because of the close proximity of the third medium, part of the signal III will pass into the third medium to form the outgoing signal V in addition to the internally reflected signal IV. Accordingly, incoming signal III is divided into reflected signal IV and outgoing signal V.

The width of the trench (or more exactly the separation distance between the first medium and the third medium is one factor that determines how much of the incoming signal III is transmitted as signal V and how much is reflected as signal IV. The material in the trench is another factor that determines how much of the incoming signal III is transmitted as signal V and how much is reflected as signal IV. These factors will be discussed in more detail later. Accordingly, in one embodiment of the invention, arbitrary dividing ratios can be achieved through control of the trench width. Efficiencies in excess of 95% were found by simulation in a 2 micron footprint coupler.

Thus, in one embodiment of the invention, based on a selection of the material of the waveguide and a selection of the material that fills the trench, the width of the trench is selected such that coupling of 95% is achieved. For example, in one embodiment of the invention, for an InP based semiconductor optical amplifier waveguide system, a free space gap of approximately 100 nm would yield a 3 dB split with a coupling efficiency of approximately 95%.

More specifically, with reference to FIG. 3, an incoming wave 40 travels along the incoming waveguide 34 and is divided into first outgoing wave 42 and second outgoing wave 44. In general, the propagation constant in the trench is approximately equal to the evanescent decay length, which is on the order of the gap. These numbers are all smaller than the free space wavelength of the signal and the wavelength of the signal in the waveguide. Under ideal conditions, almost all the energy is divided between the first outgoing wave 42 and second outgoing wave 44 with very little scattering as compared to the edge scattering described above with regard to FIG. 2.

One parameter affecting the division of the incoming wave is the index of refraction of the material in the trench or separating the waveguide portions. Frustrated total internal reflection (TIR) can be described through an analytic derivation based on a plane wave approximation to the mode. For a plane wave inside the waveguide with the index of refraction n₁ and incident on a thin barrier (a configuration of the barrier index and incident angle 45-degrees), the reflection coefficient shown in Equation (1) below, holds:

$${E}_{R} ( {n}_{1} , {n}_{2} , {θ}_{1} , {θ}_{2} , d ) = \frac{{E}_{0} ( {n}_{1}^{2} {cos}^{2} {θ}_{1} - {n}_{2}^{2} {cos}^{2} {θ}_{2} )}{( {n}_{1}^{2} {cos}^{2} {θ}_{1} + {n}_{2}^{2} {cos}^{2} {θ}_{2} + 2 {n}_{1} {n}_{2} cos {θ}_{1} cos {θ}_{2} ( \frac{1 + {e}^{j2 {k}_{0} {n}_{2} dcos {θ}_{2}}}{1 - {e}^{j2 {k}_{0} {n}_{2} dcos {θ}_{2}}} ) )} \qquad ( 1 )$$

where E_{R} is the electric field of the reflected wave, E₀ is the electric field of the incident electric field, n₂ is the index of the material filling the gap, θ₁ is the angle of incidence to the gap, θ₂ is the angle of the wave vector in the barrier, and d is a width of the barrier. Equation 1 describes the general condition of a plane wave incident on a dielectric interface transitioning from n1 to n2, with another dielectric interface (parallel to the first) a distance d away transitioning back to an index of n1, as shown for example in FIG. 3. For this particular configuration, which is not intended to limit the invention, the incident wave experiences frustrated TIR, so the angle θ₂ is imaginary.

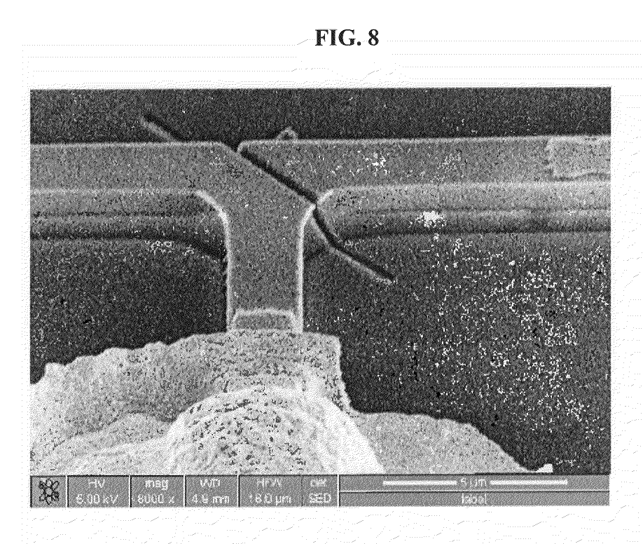

Numerically solving equation (1) for the condition of the power reflectance (E_{R}/E₀)²=0.5, FIG. 6 shows a family of curves of a resulting 3 dB coupling solution and provides the correlation between trench width and waveguide index of refraction for a variety of fill materials, i.e., dielectric layer: air (n=1), PMMA (polymethyl methacrylate) (n=1.48), photoresist SU8 (n=1.57), sapphire (n=1.75), and zirconium (n=2.1). The ranges of the plotted lines are limited by the domain over which this analysis holds, i.e., total internally reflecting waveguide and trench interfaces. In the range of polymer and glass waveguide indices, near a value of 1.5, air trenches provide trench dimensions that can be readily fabricated. With waveguide indices typical of semiconductor waveguides (n>3), the thickness of the air trench approaches results that require higher aspect ratio etching, narrower trenches or separations. The curves in FIG. 6 are asymptotic at the minimum index which meets the TIR requirements for the 45° angle of incidence.

The curves in FIG. 6 show two regimes of operation for nanoscale-separated photonic elements. On one end (i.e., the right-side as shown) is a relatively insensitive dependence between gap and material index, which would lead to stable, robust performance of optical couplers. While it might be expected that the operational wavelength dependence of devices based on an evanescent field decay across the width of the trench would have to be tightly controlled, yet within an expected spectral band this is not necessarily the case. Unexpectedly, the response is effectively flat across the commonly used telecommunication standard C-Band. Other material systems like polymers permit visible spectrum waveguides to be used. The second regime in FIG. 6 (i.e., the left-side as shown) shows a very steep dependence, which indicates the potential for sensors (discussed below).

### Optical Coupling Devices

A photonic coupler similar to that shown schematically in FIG. 3 was built and tested to confirm the above noted parameters. In this embodiment, an 88.2 GHz RF source (free space wavelength of 3.44 mm) was coupled into an alumina dielectric waveguide (n=3.13) of cross-sectional dimensions 1 mm×3.2 mm. The waveguide was cut at 45-degrees, and the second part of the waveguide was translated from touching the first waveguide part to produce less than a 1 mm gap spacing, for the intended propagation signal wavelength of 3.44 millimeters.

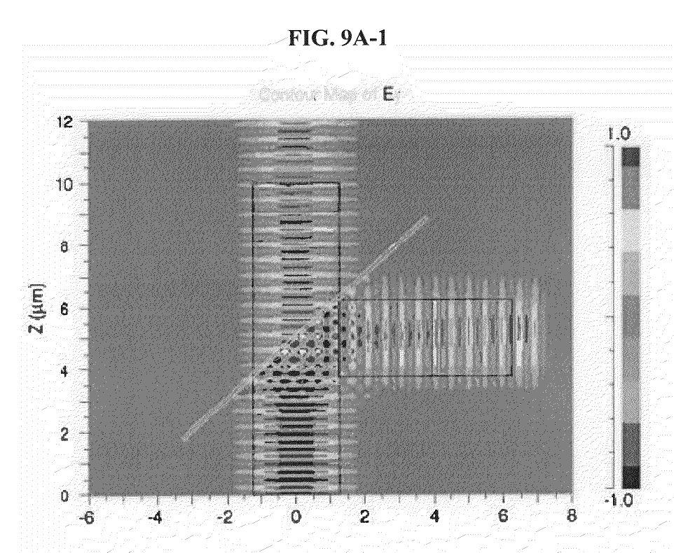

FIG. 7 shows experimental data (dots) collected from the fabricated coupler discussed above and predicted theoretical results (line). In FIG. 7, the x-axis represents a normalized power transmitted across the trench, and the y-axis represents the trench width. The behavior of the coupler follows closely predicted results.

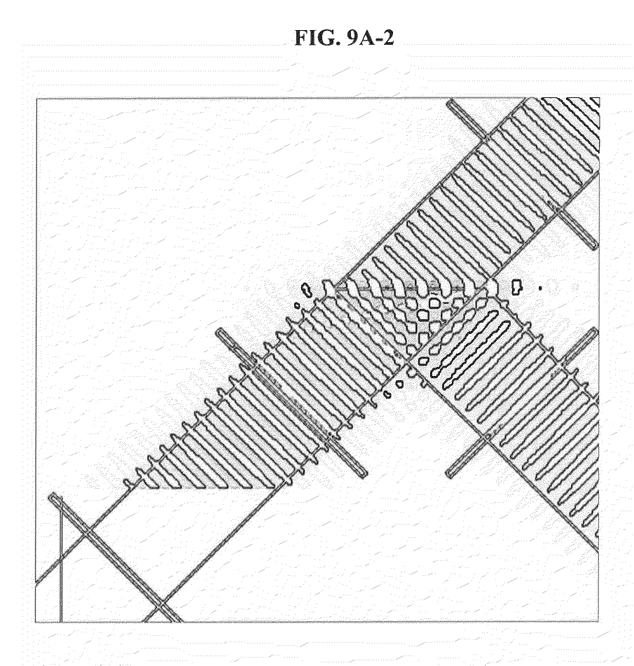

FIG. 8 shows an electron microscope image of a prototype coupler fabricated according to the structure depicted in FIG. 3. The trench was formed at a T intersection of ridge waveguides in AlGaAsP/InP. In this device, an incident wave signal would be expected to travel from left to right across the top of the T. At the intersection of the waveguides, a 45° trench deflects part of the signal down into the stem of the T. With an appropriately sized trench width, the total internal reflection will be frustrated by a short gap, and a part of the signal continues to the right. In the trench structure shown in FIG. 8, a gap of ˜500 nm exists, which for material systems such as polymers and visible wavelength signal propagation or for III-V material systems and IR wavelength signal propagation would be an appropriate gap separation.

In this configuration, arbitrary splitting ratios can be achieved through control of the trench width. Efficiencies in excess of 95% are achievable in a 2 micron footprint for the length of the coupler, permitting relatively high integration densities of couplers to be realized unlike that possible with the conventional Y couplers. For material systems with a low index of refraction, an air gap of small dimensions (e.g. >200 nm) can be used. For higher index III-V semiconductor waveguides with high refractive index, the gap can be filled with a HfO₂ and ZrO₂ dielectrics using, for example, plasma enhanced vapor deposition (PECVD), as disclosed for example in Koltunski et al., “Infrared properties of room temperature-deposited ZrO2,” Appl. Phys. Lett. 79, 320-322, (2001), and Lao et al. “Plasma enhanced atomic layer deposition of HfO₂ and ZrO₂ high-k thin films,” J. Vac. Sci. Technol. A 23, 488-496 (2005), the contents of which are incorporated herein by reference. Using these materials, the required gap width for 3 dB coupling can be sized to ˜150 microns, for wavelength of 1.5 microns.

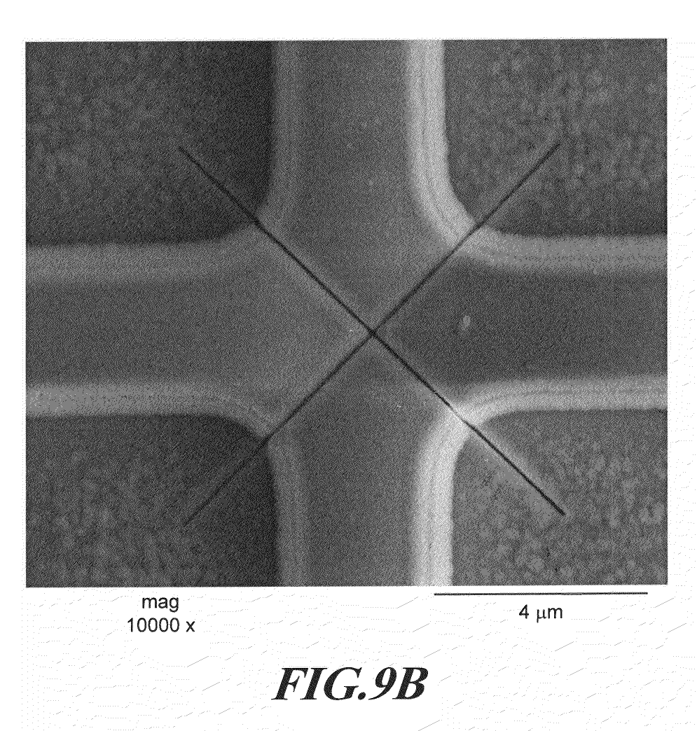

FIG. 9A-1 shows a false color contour plot for a “T” shaped waveguide, with a 105 nm air gap, and the resulting electric fields in an InGaAsP/InP multiple quantum well epitaxial waveguide structure. In the TM calculations shown in FIG. 9A-1, the ridge waveguide width was 2.5 microns. The diagonal polygon represents the air trench, and the other thin polygons are power monitors for the launch, transmission and reflection of the incident wave. In one embodiment, improved manufacturability and less sensitivity to wavelength and gap tolerances is attained by depositing a dielectric to fill the etched gap. For example, in the InGaAsP/InP device shown in FIG. 9A-1, the use of Al₂O₃ (n=11.75) extends the gap dimension to 137 nm. FIG. 9A-2 is a wavefront plot for the false-color contour plot of FIG. 9A-1.

According to one embodiment, the desired trench width in a coupler for equal coupling is 100-200 nm, for an InP semiconductor optical amplifier ridge waveguide system operating in the C band around 1.5 microns and depending on whether an air gap is used or a suitable dielectric is deposited. As discussed above, the thickness of the gap, the orientation of the gap (i.e., satisfying Snell's law), and the material filling up the gap can be chosen as desired. The depth of the trench should be such so as to substantially cover the mode of the signal. The depth of the trench in one embodiment is in the range of 2-4 microns, depending on whether the ridge is removed for better access to the mode at the expense of slightly increased losses. Adequate mode penetration (i.e. transmittal of light across the trench) is expected at trench depths of 2 μm, resulting in a 10:1 trench aspect ratio.

In another embodiment, the coupler of the invention can be a four port coupler having four optical signal lines optically connected together by coupling across multiple trench or separations. FIG. 9B is a SEM micrograph of one such coupler. A 97% efficiency is expected with the four port coupler, the efficiency of splitter being defined herein as the total energy in the outgoing signals divided by the total energy of the incoming signals.

In another application, the coupler shown in FIG. 9B could be modified to have only one trench. For example, if the trench that runs from upper left to lower right were removed, an optical signal can be input on the left waveguide. The remaining trench lets some of this input optical light pass straight through to the right waveguide, which can be directed to a first detector (e.g., a traveling wave detector). The same trench also reflects some of the light from the left waveguide into the upper waveguide, which can be directed to a second detector. By splitting the signal and using two detectors, the signal to noise can be improved.

For an input optical signal on the lower waveguide, the same phenomenon occurs. The trench lets some of the input optical light in the lower waveguide pass straight through to the upper waveguide, which can be directed to the second detector. The trench also reflects some of the light from the lower waveguide into the right waveguide, which can be directed to the first detector.

In one example of this capability, the first and second detectors represent balanced traveling wave detectors. The input optical signal can be a transmitted signal (horizontal left waveguide) that is being mixed with a local oscillator optical signal (vertical lower waveguide). The waveguides can be fabricated from a semiconductor material as noted above and can be for example an InP material. Such a configuration permits demodulation (extraction of information) of the transmitted optical signal. In another example of this capability, the input waveguides could include modulators.

In general, due to the flexibility in the photolithographic techniques discussed below, an arbitrary number of input (N ports) and output (M ports) can be fabricated by the couplers of the invention. Each trench structure can serve as either a beam splitter when viewed as one incoming signal being divided at the trench into multiple outgoing signals or as a beam combiner when viewed as multiple incoming waves being combined at the trench into one (or fewer) outgoing signals.

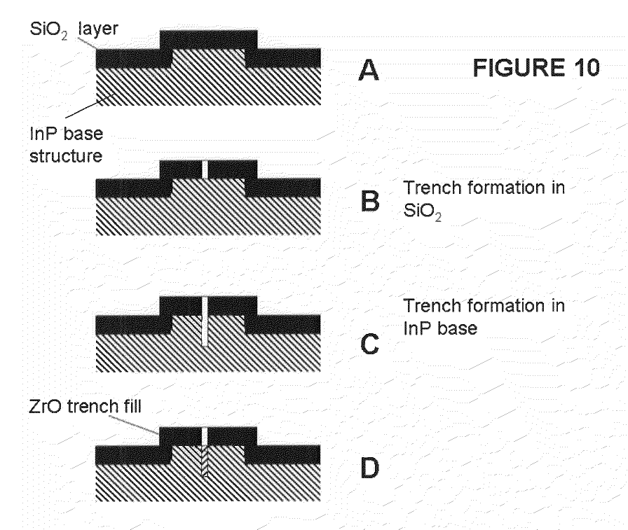

A simplified process flow is shown in FIG. 10 for the fabrication of the optical couplers of the invention.

In step A, a hard dielectric mask is deposited onto the InP substrate. Materials for the mask may include SiO₂, NiCr, SiN₂ and silesquioxene. The latter is a spin-on glass that allows low temperature processing. The mask is opened in step B by known methods. For example, the required sub-micron aperture can be cut using a focused ion beam. Kotlyar et al. for example uses chemically assisted ion beam etching (CAIBE). With this method, 170 nm holes have been formed in InGaAsP with aspect ratios of 27:1.

In Step C, an inductively coupled plasma reactive ion etch is used to cut the required trench. The depth of the trench is determined as will be discussed later. A variety of gasses are capable to fabricate deep, high aspect ratio features in InP with smooth side-walls for photonic applications. For example, Grover et al have demonstrated 600 nm features with depths greater than 5 um, with surface roughness of a few nm using CH₄—H₂—Ar plasma. Similar processing chemistry was used by Choi et al to etch functional integrated photonic devices. Chlorine based reactive ion etch has also enabled holes and gaps in InP with 10:1 and higher aspect ratios.

In step D, a high index dielectric such as TiO₂ and ZrO₂ is deposited in the trench etched in step C. Techniques such as for example chemical vapor deposition (CVD) and atomic layer deposition can be used to deposit the dielectrics. Physical vapor deposition and plasma enhanced chemical vapor deposition are also known techniques for depositing dense, transparent dielectric coatings with good adhesion for optical and photonic applications, including cladding for integrated waveguides.

Still in another embodiment, each of the incoming waveguide and the first and second outgoing waveguides are independently formed in place on common substrate 32 with the separation between the incoming waveguide and the first and second outgoing waveguides being determined by the fabrication layout.

Development of the photonic coupler of the invention has been facilitated by finite difference time domain (FDTD) simulation of the coupler structure simulating both the two-dimensional (2D) and three-dimensional (3D) structures of the photonic coupler of the invention. These simulation results complement the experimental results and are provided here to illustrate various aspects of the invention. A three layer waveguide simulation structure that was optically equivalent to the eight layer structure in Table 1 was used for simulation purposes. Tables 1 and 2 describe the layers of the complete epitaxial material used in the coupler and the 3-layer model simulation equivalents.

TABLE 1
Description of epitaxial material.

| Layer | Composition | Thickness (um) | Refractive Index |
|---|---|---|---|
| n-substrate | InP | — | 3.16492 |
| n-clad | InP | 0.5 | 3.16492 |
| n-SCH | InGaAsP (Q 1.2 um) | 0.1 | 3.33682 |
| Bulk Active | InGaAs (Q 1.55 um) | 0.05 | 3.62525 |
| p-SCH | InGaAsP (Q 1.2 um) | 0.1 | 3.33682 |
| p-spacer | InP | 0.3 | 3.16492 |
| etch stop | InGaAsP (Q 1.15 um) | 0.01 | 3.3054 |
| p-cladding | InP | 1.19 | 3.16492 |
| p-cap | InGaAs | 0.1 | 3.6 |

TABLE 2
Description of 3-layer model.

| Layer | Thickness (um) | Refractive Index |
|---|---|---|
| n-substrate | — | 3.168 |
| Layer 1 | 0.576 | 3.168 |
| Layer 2 | 0.078 | 3.784 |
| Layer 3 | 1.696 | 3.168 |
| air | 0 | 1 |

A waveguide width of 3 microns was chosen for the simulations. A 300 micron long section of waveguide was utilized to determine the fundamental mode of the waveguide. The initial signal launch was a Gaussian pulse located near the center of the active region of the material near underneath the waveguide ridge. The simulations account for the proper waveguide mode being sustained in the waveguide based on its lateral dimensions and the wavelength of the initial signal.

Indeed, regarding the fundamental mode existing in the waveguide, the E-major portion is the Eₓ field (TE with respect to a ridge top surface), whereas relatively small E-minor portion is the E_{y} field. The amplitude of the E-minor field is scaled by the magnification factor (MAG) in the plot to allow it to be observable.

The calculations provided precise engineering dimensions for a desired coupling to be used as a fabrication specification. In addition, the calculations also permitted a sensitivity analysis, or tolerance study to be performed in order to assess the impact of a given fabrication deviation. For example, the transmission of the coupler as a function of the width of the trench is calculated as per FIG. 7. Similarly, there are minor effects on the coupling due to the location of the trench along the waveguide showing a slight offset from center due to the Guoy phase shift.

The effect of the coupling on the depth of the trench was also determined. It is desirable to implement a trench depth that substantially covers the extant of the mode propagating in the waveguide. In practice, this depth can be in excess of 95% of the mode in order to maintain good efficiency.

A decrease in efficiency due to surface roughness and trench wall angle variations from normal with respect to the substrate was also determined. It is desirable to implement a surface roughness that is equivalent to a scratch and dig of λ/10, as is customary for laser optics. In practice, this entails roughness imperfections on the order of 0.1 wavelengths. Increased roughness is expected to lower the efficiency of the coupler but not substantially alter the basic function of the coupler. Similarly, it would be desirable to maintain the trench wall perfectly normal to the substrate. In practice, this angle should be less than a few degrees from normal. An increased sidewall angle will lower the efficiency of the coupler, but not substantially alter the basic function of the coupler.

In general, a photonic coupler of this invention can be created at the intersection of any two or more waveguides. While the embodiments described above utilize semiconductor waveguides fabricated on substrates, in other embodiment, the couplers would either be created free of a substrate or would have the substrate (at least in part) removed. For example, in one embodiment, a coupler without a substrate is provided with fiber optic waveguides, or rectangular polymer or glass waveguides. In this embodiment, the plurality of waveguides would be scribed or cut and polished to create an optical quality facet (or face) at its end. The waveguides would next be held in proximity and suspended with standard fixturing methods to create an effective trench between the suspended waveguides for FTIR coupling. This trench or gap could include “air” or alternatively an optical quality adhesive could be used across the gap to fix the relative positions of the waveguides. The result would be the same arrangement as described in the drawings with the exception that the substrate is not present and in its place fixturing to position the waveguides would be used for making the photonic coupler and retained if the optical quality adhesive was of insufficient strength to hold the waveguides together.

Optionally, similar technologies to those used in the fabrication of micro electro mechanical semiconductor (MEMS) devices can be used to position the gap between multiple (substrate-less) waveguides. In semiconductor MEMS devices, an “air bridge” is created by etching out one type of material from underneath another type of material. In the present invention, multiple waveguides could be formed and patterned on a substrate. Either the material of the multiple waveguides or an additional intervening material provides selectivity with regard to etch removal of all or a part of the substrate.

U.S. Pat. No. 6,812,810 (the entire contents of which are incorporated herein by reference) shows one such example of MEMS-type processing that can be used in the invention to generate multiple waveguides existing above an air bridge. Similar to that in U.S. Pat. No. 6,812,810, in one embodiment of the invention, a sacrificial layer is deposited or spun-onto a substrate such as for example an unpatterned or pre-patterned substrate. The sacrificial layer can be made of polymeric materials, such as polyimide, resist, or flowable glasses, that reflow, shrink, melt, or vaporize at elevated temperatures. On top of the sacrificial layer, suitable waveguide materials (such as for example SU8 and ploymethyacrylate PMMA or the oxides, nitrides, and dielectrics described above) are deposited and patterned to form sidewalls of the waveguides and trenches separating the waveguides. Suitable trench-fill materials (e.g., air, polymers including but not limited to SU8 and PMMA, oxides including but not limited to SiO₂, vanadium dioxide, titanium dioxide, nitrides including but not limited to silicon nitride, gallium nitride) and other dielectrics can be filled in the trench.

Afterwards, the sacrificial layer is removed for example by the application of heat, as in U.S. Pat. No. 6,812,810.

U.S. Pat. No. 7,128,843 (the entire contents of which are incorporated herein by reference) shows another example of MEMS-type processing that can be used in the invention to generate multiple waveguides existing above an air bridge. Similar to that in U.S. Pat. No. 7,128,843, in one embodiment of the invention, a sacrificial layer is deposited or spun-onto a substrate such as for example an unpatterned or pre-patterned substrate. The material for the sacrificial layer is chosen such that the chemical used to eventually dissolve away the sacrificial layer does not attack a polymeric film, preferably a polyimide film used to provide stress for release of patterned waveguides from the underlying substrate. For example, the sacrificial layer in this embodiment can be a metal, SiO₂, KCl, or the like, and can be for example 1 μm thick.

U.S. Pat. No. 7,471,440 (the entire contents of which are incorporated herein by reference) shows another example of MEMS-type processing that can be used in the invention to generate multiple waveguides existing above an air bridge. Similar to that in U.S. Pat. No. 7,471,440, in one embodiment of the invention, a sacrificial material including one of amorphous carbon, polyarylene, polyarylene ether, and hydrogen silsesquioxane can be deposited over a substrate such as for example an unpatterned or pre-patterned substrate. The polyarylene, polyarylene ether, and hydrogen silsesquioxane can be spin-coated on the surface. The sacrificial layer can first be hardened before the subsequent build up, the deposited amorphous carbon can harden by thermal annealing after the deposition by CVD or PECVD process. SILK or HSQ can be hardened by UV exposure and optionally thermal and plasma treatments. Structures such a multiple waveguides are patterned on these sacrificial materials. An opening is provided in the superstructures above the sacrificial layer or elsewhere, whereby the opening(s) can provide access from outside to the sacrificial material for removal of the sacrificial material by for example. These sacrificial materials provide excellent thermal stability (as compared to photoresist sacrificial materials) and have a relatively low coefficient of thermal expansion. These sacrificial materials can maintain mechanical strength at temperatures up to 500° C., which is higher than the temperature range within which a photoresist could be used. The higher-operation temperature allows high-temperature processing to be performed after the introduction and hardening of the disclosed sacrificial materials.

These sacrificial materials can be removed for example by isotropic etching in dry processes such as for example isotropic plasma etching, microwave plasma, or activated gas vapor.

Sensing Devices

The couplers depicted above are suitable for also for sensing devices. As discussed above, the second regime in FIG. 6 (i.e., the left-side as shown) shows a very steep dependence, which indicates the potential for sensors. For example, a divided waveguide attached to a substrate (optionally without even a third waveguide section) would have a separation distance which would change with the thermal expansion and/or contraction of the substrate under differing temperatures and would have different percentages of light transmitted across the separation depending on the temperature of the substrate. For example, a divided waveguide attached to a flexible substrate (e.g., on a pressure diaphragm) would have a separation distance which would change with the deflection of the substrate under differing pressure loads and would have different percentages of light transmitted across the separation depending on the pressure on the diaphragm. For example, a divided waveguide having an open trench structure with no dielectric fill, if placed in a changing gaseous or liquid environment, would by the changing dielectric constant of the gaseous or liquid environment have different percentages of light transmitted across the separation depending on the index of the gaseous or liquid environment. Additionally, the detection of chemical and biochemical species follows from the binding of chemical species in or around the gap. The binding of these species, will again change the dielectric constant of the trench thereby altering the optical coupling across the gap.

In one embodiment, the width of the gap or the refractive index of the material in the gap is variable, permitting the coupling region across the gap to be a sensing element. For example, the substrate supporting the gap could flex or expand or contract changing the dimension (i.e., width) of the gap, as could be caused due to physical changes in an environment thereabout such as for example a temperature change, a pressure change, and a chemical environment change. Furthermore, an electro-optic material could fill the gap. Under this embodiment, electric field induced changes in the refractive index of the gap fill material would act as either a sensor or would act to effect coupling in a filter or switching operation.

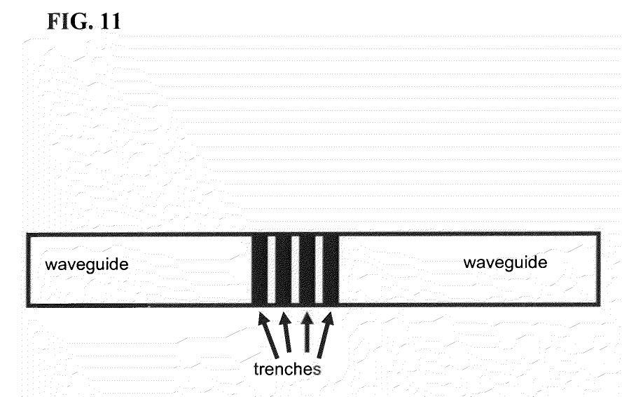

In various embodiments of the invention and particularly with regard to the sensing devices, a more complicated gap allows extended capabilities. FIG. 11 shows a multi-trench structure using chemical beam assisted ion beam etching in a chlorine-containing atmosphere. In this configuration, the multiple trenches have a large surface area by which attachment of chemical species (adsorption or absorption) would change the dielectric constant from air to a higher value and thus change the coupling from one waveguide element to another. Each trench has a width small enough for energy from an optical signal in one waveguide region (i.e., the non-etched material) to be transmitted across each width to the next region of unetched waveguide material. The collection of trenches is aligned as a single trench would be to otherwise permit total internal reflection except for the coupling and the propagation of the evanescent wave across each of the trenches.

In one embodiment of the invention, a patterned metal cladding is provided on the edges of the waveguides at the gap as a metal “trim” nanostructure to enhance coupling, to boost sensing capability, or to tune the operation of the element to a specific spectral response. The operation of this device is predicated on surface plasmon effects whereby field enhancements at certain resonant wavelengths are evident from the scale and shape of the patterned metal. To fabricate the nanostructured metal trim, a thin layer of metal, platinum, titanium or nickel, for example is deposited onto the end of the waveguide. The undesired metal may be removed using focused ion beam milling, or a fluorine etch. This structure can lead to a chemical sensor with single binding event precision. Controlled operation can also be contemplated through the injection or external stimulation of current onto this metal patterned trim.

Lattice Filters

As discussed above, the coupler 30 shown in FIG. 3 represents a 100-fold reduction in footprint relative to the conventional coupler shown in FIG. 1. As a consequence, propagation delay along lengthy waveguide guide elements is reduced by the shorter scale of coupler 30, whose attributes are more prominent for example in active lattice filter used for semiconductor optical amplifiers.

In one embodiment of the invention, the coupling elements described above are incorporated in the optical signal lines in a lattice filter configuration. For example, the coupling elements of the invention can be used for the lattice elements described in U.S. Pat. No. 6,687,461, the entire contents of which is incorporated herein by reference in its entirety. U.S. Pat. No. 6,687,461 describes an optical signal processing apparatus based on an active optical lattice filter. An active optical lattice filter permits ultra-high bandwidth signal processing of optical signals. The lattice sections are constructed of a semiconductor material so that the device may be used as an optoelectronic component of an optical communications system. A control voltage is applied to each optical amplifier thereby enabling a user to electronically control and tune the optical transfer function of the device. The lattice parameters may be adjusted to produce a tunable oscillation to produce a precision optical line frequency. Precision optical line frequencies are useful in dense wavelength division multiplexers.

Specifically, as described therein, a wavelength division demultiplexer separates a multi-component optical input signal into various sub-components. The wavelength division multiplexer includes a plurality of the above noted optical lattice filters. For each optical lattice filter, part of an optical input signal passes through as an output signal and part is reflected back as a reflected signal. The reflected signal has a laser line frequency component removed. The removed component exits from one of the transmission outputs.

In the context of a wavelength division multiplexed optical communication system, multiple optical communication signals are sent down a single fiber. Each optical communication signal has a laser line frequency onto which is modulated a high-speed data sequence. At the receiving end of the fiber, the wavelength division demultiplexer isolates each individual optical communication signal by generating optical filter transfer functions which optically switches the desired optical communication signal to a given output port. The optical switches in the lattice filter described above and in U.S. Pat. No. 6,687,461, instead of using the conventional Y couplers, can use the couplers of this invention.

U.S. Pat. No. 7,215,462 B2, which is incorporated herein by reference in its entirety, discloses a multi-section filter for use in processing optical signals and other signals. Filters in U.S. Pat. No. 7,215,462 B2 can be configured in numerous forms, including IIR and FIR filters, and both linear and 2-D active optical lattice filters. Filter sections are coupled together, and the invention provides for the coupling in the photonic realization of the active optical lattice filters. These couplers can be used instead of the surface grating couplers, or instead of coupling elements between the gain/delay blocks.

Numerous modifications and variations of the invention are possible in light of the above teachings. It is therefore to be understood that within the scope of the appended claims, the invention may be practiced otherwise than as specifically described herein.

1. A photonic coupler comprising:
a substrate;
first and second waveguides disposed along a longitudinal direction of the substrate for propagation of respective first and second optical signals along the longitudinal direction;
a coupling region between the first and second waveguides and including a medium of a refractive index different from the first and second waveguides;
said coupling region having a width extending from the first waveguide to the second waveguide and a breadth extending laterally to form an angle to the longitudinal direction for frustrated total internal reflection of the first optical signal at an interface between the coupling region and the first waveguide; and
said frustrated total internal reflection coupling a first part of the first optical signal into the second waveguide to form said second optical signal.

2. The photonic coupler of claim 1, wherein said width is within two wavelengths of the first optical signal.

3. The photonic coupler of claim 1, wherein said width is within one wavelength of the first optical signal.

4. The photonic coupler of claim 1, wherein said coupling region is configured:
to couple the first part of the optical signal in the first waveguide to the second waveguide via an evanescent wave propagating along an interface between the dielectric medium and the first waveguide, and
to reflect a second part of the first optical signal.

4. The photonic coupler of claim 1, further comprising:
a third waveguide optically coupled to the coupling region.

5. The photonic coupler of claim 4, wherein said coupling region comprises an optical splitting element which couples said first part of the first optical signal into the second waveguide to form the second optical signal and splits a second part of the first optical signal into the third waveguide to form a third optical signal.

6. The photonic coupler of claim 4, wherein said coupling region comprises an optical combining element which forms a resultant signal in the second waveguide from input signals transmitted in the first and third waveguides.

7. The photonic coupler of claim 1, wherein said angle is at least greater than an angle for said total internal reflection.

8. The photonic coupler of claim 1, wherein said coupling region comprises a sensing element, and
said width is configured to change dimensions due to physical changes in an environment thereabout.

9. The photonic coupler of claim 8, wherein the physical changes comprise at least one of a temperature change, a pressure change, and a chemical environment change.

10. The photonic coupler of claim 1, wherein at least one end face of the first and second waveguides is configured for chemical species attachment thereto to alter a dielectric constant of the coupling region.

11. The photonic coupler of claim 1, wherein the medium comprises air.

12. The photonic coupler of claim 1, wherein the dielectric medium comprises at least one of polymethyl methacrylate, photoresist, sapphire, and zirconium.

13. The photonic coupler of claim 1, wherein the coupling region comprises a trench formed in an optical material deposited for said first and second waveguides.

14. The photonic coupler of claim 1, wherein the coupling region comprises a trench formed into the substrate, said substrate having diffused regions forming said first and second waveguides.

15. The photonic coupler of claim 1, wherein the first and second waveguides are respectively formed on the substrate, and a space between the first and second waveguides forms said coupling region.

16. The photonic coupler of claim 1, further comprising:
third and fourth waveguides intersecting the first and second waveguides, and
said coupling region comprises two coupling regions crossing each other at an intersection point of the first, second, third, and fourth waveguides.

17. The photonic coupler of claim 1, further comprising:
additional waveguides optically coupled to the coupling region.

18. The photonic coupler of claim 1, wherein the first and second waveguides comprise waveguides are disposed on the substrate:

19. The photonic coupler of claim 1, wherein the first and second waveguides comprise waveguides are formed in the substrate.

20. The photonic coupler of claim 1, wherein the first and second waveguides comprise respective ones of an M×N waveguide array, where M and N are integers.

21. The photonic coupler of claim 1, wherein:
a first wavelength of the first optical signal is transmitted across the coupling region into the second waveguide by frustrated total internal reflection; and
a second wavelength of the first optical signal shorter in wavelength than the first wavelength is reflected by the coupling region.

22. The photonic coupler of claim 21, wherein said width is less than two wavelengths for the first wavelength and is in excess of two wavelengths for the second wavelength of the first optical signal.

23. An optical sensor comprising:
a substrate;
first and second waveguides disposed along a longitudinal direction of the substrate for propagation of respective first and second optical signals along the longitudinal direction;
a coupling region between the first and second waveguides and including a dielectric medium of a refractive index different from the first and second waveguides;
said coupling region having a width extending from the first waveguide to the second waveguide and a breadth extending laterally to form an angle to the longitudinal direction for frustrated total internal reflection of the first optical signal at an interface between the coupling region and the first waveguide;
said width of said coupling region configured to change dimensions due to physical changes in an environment thereabout.

24. The optical sensor of claim 23, wherein the coupling region comprises a variable width region or a variable refractive index material.

25. The optical sensor of claim 24, wherein the coupling region comprises an electro-optic material.

26. An optical signal processor comprising:
a substrate;
first and second waveguides disposed along a longitudinal direction of the substrate for propagation of respective first and second optical signals along the longitudinal direction;
a coupling region between the first and second waveguides and including a medium of a refractive index different from the first and second waveguides;
said coupling region having a width extending from the first waveguide to the second waveguide and a breadth extending laterally to form an angle to the longitudinal direction for frustrated total internal reflection of the first optical signal at an interface between the coupling region and the first waveguide;
said frustrated total internal reflection coupling a first part of the first optical signal into the second waveguide to form said second optical signal and splitting a second part of the first optical signal into the third waveguide to form a third optical signal.

27. The optical signal processor of claim 26, wherein said width is within two wavelengths of the first optical signal to couple the first part of the first optical signal into the second waveguide and to split the second part of the first optical signal into the third waveguide to form the third optical signal.

28. An optical signal processor comprising:
a substrate;
plural waveguides disposed along a longitudinal direction of the substrate for propagation of respective optical signals in the plural waveguides along the longitudinal direction;
a coupling region between the plural waveguides and including a medium of a refractive index different from the waveguides;
said coupling region having a width extending from the first waveguide to the second waveguide and a breadth extending laterally to form an angle to the longitudinal direction for frustrated total internal reflection of the first optical signal at an interface between the coupling region and the first waveguide; and
said plural waveguides comprising an M×N waveguide array, where M and N are integers.

29. The optical signal processor of claim 26, wherein said M×N waveguide array comprises a 1×2 array.

30. The optical signal processor of claim 26, wherein said M×N waveguide array comprises a 4×4 array.

31. A method for processing optical signals, comprising:
sending a first optical signal into a first waveguide of the photonic coupler;
splitting the first optical signal at a coupling region between the first waveguide and a second waveguide which is optically coupled to the first waveguide, said coupling region comprising a medium having a refractive index different from the first and second waveguides, having a width extending from the first waveguide to the second waveguide and a breadth extending laterally to form an angle to the longitudinal direction for frustrated total internal reflection of the first optical signal at an interface between the coupling region and the first waveguide;
transmitting a part of the first optical signal in the first waveguide across the width of the coupling region to form a second optical signal in the second waveguide; and
transmitting the second optical signal along a length of the second waveguide.

32. A photonic coupler comprising:
first and second waveguides configured to propagate respective first and second optical signals; and
an intersection of the first and second waveguides comprising a coupling region between the first and second waveguides such that a part of the first optical signal propagating in the first waveguide is coupled by frustrated total internal reflection into the second waveguide to produce the second optical signal.

33. The photonic coupler of claim 32, further comprising:
a substrate supporting at least one of the first and second waveguides.
